(19) United States
(12) Patent Application Publication
(10) Pub. No.: US 2009/0016804 A1
(43) Pub. Date: Jan. 15, 2009

(54) Written record pencil of s form to use liquid

(76) Inventor: Byeongsam Kim, Chollabuk-Do (KR)

Correspondence Address: John W. Renner;Renner Otto Boisell & Sklar LLP, 1621 Euclide Avenue, Nineteenth floor, Cleveland, OH, 44115, US

(21) Appl. No.: 11/659,400

(22) PCT Filed: Aug. 3, 2005
(86) PCT No.: PCT/KR2005/002375

§ 371 Date: Feb. 2, 2007

(30) Foreign Application Priority Data
Aug. 4, 2004 (KR) 20-2004-0022244

(51) Int. Cl. B43K 8/03

(52) U.S. Cl. 401/206

(57) ABSTRACT

This is about liquid pens that are used on boards and blackboards (15). there is a back cap (1) which is consists of the male screw in the outside and has female screw structure, is connected to the cylinder (2). The inside the liquid cylinder body (2) has one steel ball and front side of the cylinder body (2) has male screw, and the outlet cap (4) is connected to the inside the liquid cylinder body (2). The elastic spring (6) is in the outlet cap and valve path (7) is connected into the inside the elastic spring. In the front of the valve path (7), there is a supporting bump (8), and this supporting bump is connected to the oil path (9), also the oil path (9) is in the cylinder cap (10) that is connected with the cylinder front and the oil path is projected in front of the cylinder cap (10). This projected oil path (9) is combined with the front cap (12) which is connected with the absorbing filter (11) to the inside, and in the front of the front cap (12) is connected with the fixed projected tip (13). This projected fixed tip (13) and the front cap (12) is connected with the front cover (14). The above is the main technique of this liquid pen. This pen has very practical function and shape. If the liquid is dried while you are using it, it opens the oil path (9) so the charged liquid can flow out. It can prevent the waste and evaporation of the liquid, also we can use the liquid in one action, so it is very convenient.

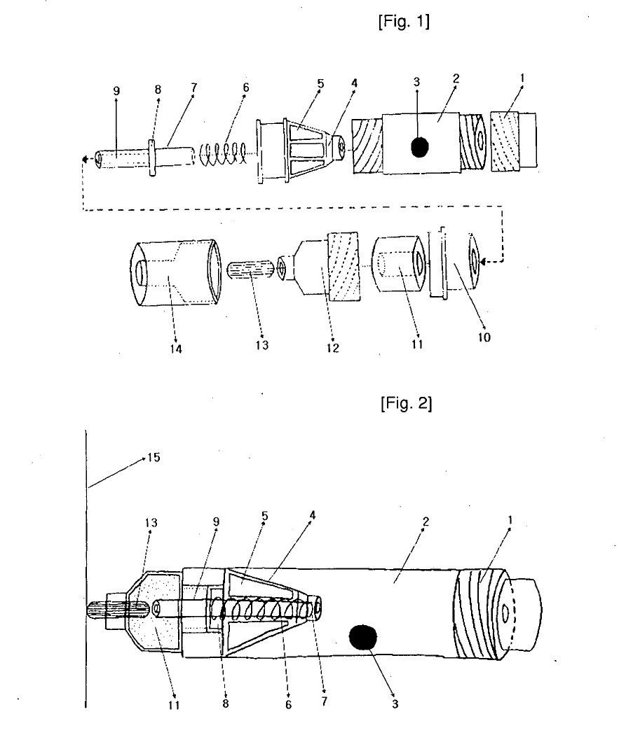

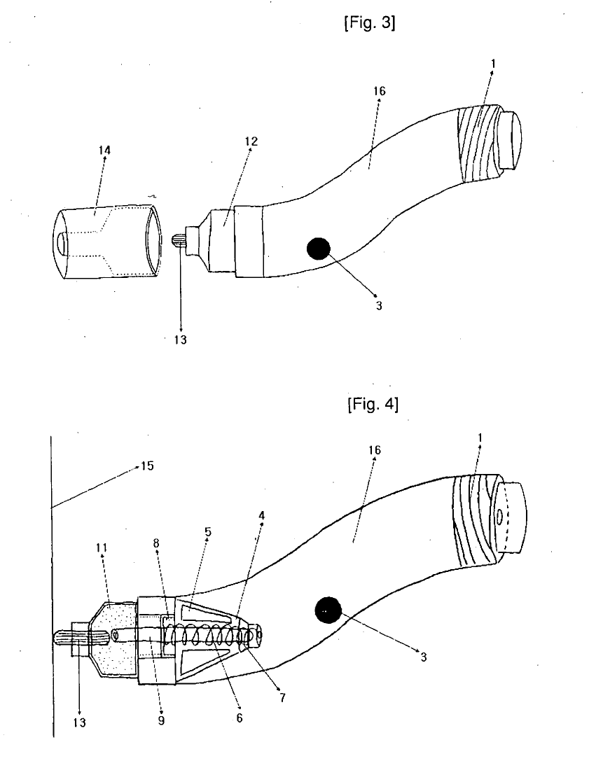

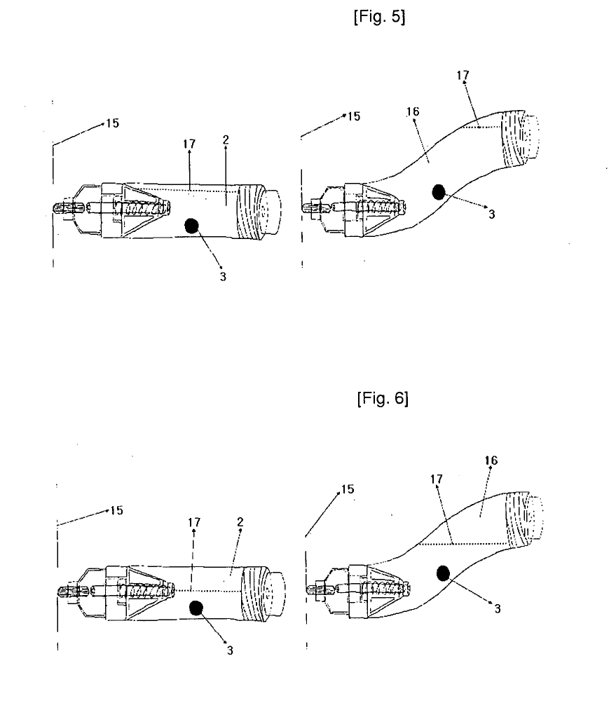

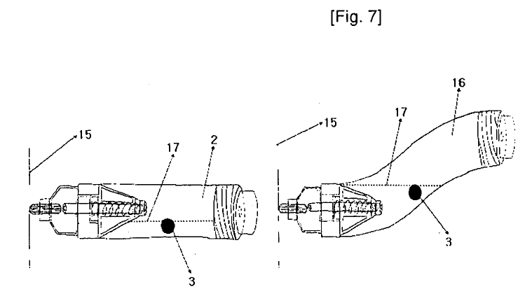

### TECHNICAL FIELD

This is about the invention of an S-shaped pen. Normally, the liquid in the pen is blocked to decrease leaking or evaporation, but when you use it, the small pressure and liquid inertia move the liquid in the pen to the front of the pen.

### BACKGROUND ART

The most common pen type has a ball at the end so the liquid can come out when the ball moves. The other type has a cylinder that has liquid in it and the small amounts of liquid can be moved to the fixed tip at the end. For this kind of pen, there is an absorbent filter in the cylinder, and when the small amounts of liquid is absorbed into the absorbing filter, it moves to the fixed tip so we can write. Therefore, the liquid of this type of pen can easily be evaporated and the amount of liquid that can be absorbed is very limited, so it is inconvenient to use it for a long time. To solve these problems, the liquid thread was put in the cylinder in order to discharge the small amounts of liquid which was charged in the liquid thread.

### DISCLOSURE OF INVENTION

### Technical Problem

This traditional technique is explained with the attached drawing. Drawing 1 is a decomposition sectional drawing of the pen that has a liquid outlet (5) which followed the traditional technique, and drawing 2 is the sectional drawing (5) of a pen with a liquid outlet. As you can see, there is a hole in the back of the liquid cylinder body (2), so liquid can be charged, and the back cap (1) which consists of the male screw in the outside and female screw on the inside, is connected to the cylinder. The inside the liquid cylinder body (2) has a steel ball that can be mixed with the charged liquid by shaking, and on the front, outside of the body (2) there is a male screw, and the outlet cap (4) is connected to the inside the liquid cylinder body (2) so liquid can go out into the cylinder. The elastic spring (6) is in the outlet cap and valve path (7) is connected to the inside the elastic spring. In the front of the valve path (7), there is a supporting bump that can receive the elasticity of the elastic spring (6), and this supporting bump is connected to the oil path (9) which will make the liquid come out from the liquid cylinder body (2), also the oil path (9) is in the cylinder cap (10) that is connected with the cylinder front and the oil path is projected in front of the cylinder cap (10). This projected oil path (9) is combined with the front cap (12) which is connected with the absorbing filter (11) to the inside, and in the front of the front cap (12) is connected with the fixed projected tip (13). Therefore, if there is no tension that presses the fixed tip (13), the oil path can be blocked by the supporting bump (8) which is compressed by the elastic spring, so the liquid in the liquid cylinder body (2) doesn't come out to the oil path, and the absorbed liquid on the absorbing filter (11) move to the fixed tip (13) so we can write just for a while. When the liquid which was absorbed in the absorbing filter (11) is worn out so the letter became faint, then the fixed tip (13) make the tension to the upside so the fixed tip (13) pushes the oil path (9) which is in front of the cylinder cap (10), so valve path (7) can open the oil path (9). Therefore, the liquid in the cylinder body (2) can be supplied and absorbed into the absorbing filter (11) through the opened oil path (9). In contrast, if the tension on the fixed tip is released, then, the supporting bump (8) can be recovered by the elasticity of the elastic spring which is combined with the valve path (7), so the oil path (9) will be blocked, and the cylinder body (2) will be maintained the blocking, so we can write with the ink from the absorbing filter (11). However, the following problems did arise. When it pushes the fixed tip (13) to make it go up, pressure is applied to the cylinder body (2) which is combined with the fixed tip (13), however, the pressure is too weak, so the liquid which should discharged to the fixed tip (13) will not discharged well. Therefore when the tension is given to the top or bottom several times, then, the liquid comes out without control.

### Technical Solution

This is invented to solve these problems. Because the cylinder body (2) is S-shaped, the liquid will stay in the bottom of the cylinder body (16) for the inertia, so when the small pressure occurs in the cylindrical body (16) which has liquid in it, the oil path (9) will be automatically opened so the liquid can be flow out effectively, and when the pressure is released, the oil path (9) will be blocked to prevent that too much liquid flow out. Therefore this S-shaped pen is to make the liquid flow out smoothly and balanced even though there is some natural pressure in the cylinder.

### ADVANTAGEOUS EFFECTS

In this invention, the S-shaped cylinder body (16) can always gather liquid in the front through it'S-shaped and structure of the container and the inertia, and through the interaction between the outlet cap (4) which is combined with the cylinder body (16) and the oil path (9), the liquid in the S-shaped cylinder body (16) can be used immediately. Moreover, because the cylinder body (2) is S-shaped, therefore, if it is used on the blackboard, the liquid will be gathered in the outlet cap (4) area, so even though, the amounts of the charged liquid is not much, it doesn't make the letter faint. Also, we dont need to grab S-shaped cylinder body (16) hard, but can grab it softly to write, which will satisfy the consumer's taste.

### BRIEF DESCRIPTION OF THE DRAWINGS

Drawing 1: Decomposition sectional drawing of the pen for blackboard, followed the traditional technique.

Drawing 2: Sectional drawing of the pen for blackboard, followed the traditional technique.

Drawing 3: Slide Drawing for S-shaped liquid pen, followed this invention

Drawing 4: Sectional drawing of the S-shaped liquid pen, followed this invention.

Drawing 5: Comparison drawing with the liquid line (17) between the pen for black board and S-shaped pen when there are enough liquid.

Drawing 6: Comparison sectional drawing with the liquid line (17) between the pen for black board and S-shaped pen when there are 50% of liquid.

Drawing 7: Comparison sectional drawing with the liquid line (17) between the pen for black board and S-shaped pen when there are less than 30% of liquid.

### SIGNS FOR THE MAIN PART IN DRAWING

*141: Back cap, 2: Cylinder body, 3: Steel ball for mixing, 4: Outlet cap, 5: Outlet hole for liquid, 6: Elastic spring, 7:Valve path, 8: Supporting bump, 9: Oil path, 10: Cylinder cap, 11: Absorbing filter, 12: Front cap, 13: Fixed tip, 14: Front cover, 15 Black board, 16:S-shaped cylinder body, 17: Liquid line.

### BEST MODE FOR CARRYING OUT THE INVENTION

The S-shaped cylinder body should be combined with the back cap and the steel ball for mixing should be in the S-shaped cylinder body. The outlet cap should be in the S-shaped cylinder body and the elastic spring which is combined with the valve path should be in this outlet cap, also the supporting bump should be combined on the front of the valve path, and the oil path should be connected in the front of the supporting bump. There should be a cylinder cap on the surface of the oil path, and the absorbing filter should be combined with the cylinder cap that is in the front cap, so it can be combined with the male screw at the front surface of the S-shaped cylinder body, and can be connected with the fixed tip which projected to the front of the front cap. This S-shaped liquid pen should also include the front cover that is combined with the surface of the front cap.

### MODE FOR THE INVENTION

To realize the above purpose, as drawing 3 and 4, there is a hole in the back, so the liquid can be charged, also the S-shaped cylinder body (16) which has a female screw on the outside surface is connected with the back cap (1) that has a female screw inside the back of the S-shaped cylinder body to block the leaking of the liquid. This S-shaped body (16) has a male screw on the outside front part and has a steel ball for mixing (3) the liquid by shaking in it, also the outlet cap (4) is combined in the front of the S-shaped cylinder body (16), so the liquid can flow out. There is an elastic spring (6) in the outlet cap (4), and a valve path (7) in the elastic spring (6). In the front of the valve path (7), there is a supporting bump that can control the liquid's outflow, and the oil path (9) is connected in the front of the supporting bump, so the liquid can flow out. The liquid that flows out through the oil path (9) will be gathered in the absorbent filter (11) that is connected with the front cylinder cap (10), through the cylinder cap which is connected on the outside of the oil path. The front cap (12) is connected on the front of the S-shaped cylinder body (16) that has a male screw on the outside and fix the absorbing filter (11) in the body. The front cap (12) is projected, and the fixed tip (13) which pushes to the top and bottom to make the liquid flow out from the S-shaped cylinder body (16) is connected in the front side of the front cap (12). The front cover (14) is connected on the outside of the front cap (12). The above is the main technique of this S-shaped liquid pen. Drawing 5 shows the case when the traditional pen is used on the blackboard and the S-shaped liquid pen is used on the blackboard with enough liquid charged in the cylinder body (16). Drawing 6 shows the case when the traditional pen is used on the blackboard and the S-shaped liquid pen is used on the blackboard with 50% of liquid charged in the cylinder body (16), but because of the structure of the S-shaped cylinder body (16), inertia became stronger. Drawing 7 shows the case when the traditional pen is used on the blackboard and the S-shaped liquid pen is used on the blackboard with 30% of liquid charged in the cylinder body (16), but because of the structure of the S-shaped cylinder body (16), the inertia increases in strength.

### INDUSTRIAL APPLICABILITY

This is about the invention of the S-shaped pen. Normally, the liquid in a pen is blocked to decrease leaking or evaporation, but when you use it, the small pressure and liquid inertia move the liquid in the pen to the front of the pen. We expect the high demands in this industry.

### SEQUENCE LISTING

not concerned

1. The back cap is connected with the S-shaped cylinder body. This S-shaped body has a steel ball for mixing the liquid, also the outlet cap is combined in the front of the S-shaped cylinder body. There is a elastic spring in the outlet cap, and valve path in the elastic spring. In the front of the valve path, there is a supporting bump. The oil path is connected in the front of the supporting bump. There is a cylinder cap which is connected with the outside of the oil path. The front cap which is connected with the absorbing filter inside is connected with the cylinder cap, and it is connected on the front of the S-shaped cylinder body that has a male screw on the outside. The front cap is projected, and the fixed tip. The front cover is connected on the outside of the front cap. The above is the main technique of this S-shaped liquid pen.

2. A liquid pen comprising:
a cylinder body;
a back cap coupled to a rear part of the cylinder body;
a steel ball installed in the cylinder body for mixing liquid;
an outlet cap coupled to a front part of the cylinder body;
a valve path provided at a front portion thereof with a supporting bump and installed in the outlet cap;
an elastic spring coupled with the valve path and installed in the outlet cap;
an oil path integrally formed with a front portion of the supporting bump;
a cylinder cap fitted around the oil path and introduced into the outlet cap;
a front cap positioned at a front portion of the cylinder cap and screw-coupled with a male screw section formed at a front outer peripheral surface of the cylinder body;
an absorbing filter installed in the front cap;
a fixed tip protruding from a front portion of the front cap; and
a front cover for covering an outer peripheral surface of the front cap,
wherein the cylinder body has a curvature structure similar to an S-shape, so predetermined pressure and inertia are applied to liquid contained in the cylinder body, so that the liquid is smoothly and stably guided toward the outlet cap.
